(19) United States
(12) Patent Application Publication
(10) Pub. No.: US 2024/0347729 A1
(43) Pub. Date: Oct. 17, 2024

(54) ANODE MATERIAL

(71) Applicant: SGL CARBON SE, Wiesbaden (DE)

(72) Inventors: Ivano GALBIATI, Meitingen (DE); Alberto BIANCOLI, Meitingen (DE); Andreas KLEIN, Meitingen (DE); Daniel SZLACHETA, Novy Sacz (PL)

(73) Assignee: SGL CARBON SE, Wiesbaden (DE)

(21) Appl. No.: 18/294,673

(22) PCT Filed: Aug. 4, 2022
(86) PCT No.: PCT/EP2022/071995

§ 371 Date: Feb. 2, 2024

(30) Foreign Application Priority Data
Aug. 4, 2021 (DE) 10 2021 120 322.8

(51) Int. Cl. H01M 4/587; C01B 32/205; H01M 4/02

(52) U.S. Cl. CPC H01M 4/587; C01B 32/205; C01P 2004/03; C01P 2004/51; C01P 2006/11; C01P 2006/40; H01M 2004/027

(57) ABSTRACT

An anode material, an electrode including the anode material, a battery including the electrode a method of manufacturing the anode material and the use of the anode material.

### FIELD

The present disclosure relates to an anode material, an electrode comprising the anode material, a battery comprising the electrode, a method of manufacturing the anode material and the use of the anode material.

### BACKGROUND

Lithium-ion batteries are rechargeable energy storage systems (secondary batteries) that have the highest energy density of the chemical and electrochemical energy storage systems, currently up to 250 Wh/kg, for example. The lithium-ion batteries are mainly used in the field of portable electronic devices, such as for laptops, computers or mobile phones, and in the field of means of transport, such as for bicycles or automobiles with electric drives.

For electromobility, higher energy densities of lithium-ion batteries are necessary to increase the range of the vehicles. For portable electronic devices, it is necessary to extend the service life with one battery charge.

The current lithium-ion batteries cannot meet the fast rate of charge requirement to achieve an acceptable charging time of for example an electric vehicle. One of the limiting factors of the performance during fast charge is recognized to be the low wettability between electrode and electrolyte during the production of the cell. With increasing of the density of the electrode required to maximize the energy density and power density needed in automotive the wettability between the electrode and electrolyte is further decreased. Compared with the material used for the cathode, graphite anode materials are particularly affected from the wettability decrease with the increasing of the electrode packaging mainly because of the mechanical deformation caused from the electrode pressing process.

### SUMMARY

The object of the present disclosure is therefore to provide an anode material, the method of production and the use which overcomes or at least mitigates the above disadvantages of the prior art.

The present inventors have investigated how compaction of the graphite particulates influences the wettability and have surprisingly found that tap density (also called tapped density) and the particle size distribution are important parameters governing the wettability of the graphite anode material. The tapped density is a well-known parameter in the art and describes an increased bulk density attained after mechanically tapping a container containing the powder sample. The details of its measurement will be elaborated below. The particle size distribution is also a well-known parameter. It will also be described in more detail below. The present inventors have found that the combination of relatively small particle sizes with a relatively low packing density as is reflected by a low tapping density is greatly improving the wettability of the particulate anode material. Without wishing to be bound by theory, these findings can be rationalized as follows: A low tapped density means that the materials is not as compacted and contains more void spaces which are accessible for the electrolyte. A smaller particle size (as reflected by a low D99-value of the particle size distribution) means that the surface area is larger. The combination the larger surface area given for the smaller particle size with a low tapped density means that the compacted anode material will have a high capillarity due to the many more hollow interstices and the large surface area within the compacted material. This capillarity can be expected to facilitate the wetting of the particle surfaces.

Accordingly, in a first aspect of the present disclosure, there is provided a particulate anode material for a lithium ion battery comprising graphite particles, wherein the particulate anode material has D99-value for its particle size distribution of 20-75 μm and a tap density after 1500 tamps of 0.7-1.2 g/cm³, wherein the tap density after 1500 tamps and the particle size fulfill the relationship of formula (I):

$$tap density after 1500 tamps * D 99 < 55 ( g / {cm}^{3} ) * μm \qquad ( I )$$

The above tap density is defined as the tap density after 1500 tamps, i.e. after being subjected to 1500 mechanical tapping events. The large number of tamps ensures that the material has achieved its maximum possible tap density (which gradually increasing with each tamp until it reaches a constant value). As said, the measurement details will be discussed below.

In some embodiments, the D99-value is 20-60 μm, more specifically 25-50 μm, and in particular 30-45 μm.

In some embodiments, wherein the tap density after 1500 tamps of 0.75-1.15 g/cm³, more specifically 0.80-1.10 g/cm³, and in particular 0.85-1.00 g/cm³. A too low tap density it is in general not desirable because it limits the maximal electrode density that can be achieved by compression. Furthermore, the interface is reduced and therefore unwanted side reactions increase.

In some embodiments, the tap density after 1500 tamps and the particle size fulfill the relationship of formula (II):

$$tap density after 1500 tamps * D 99 < x ( g / {cm}^{3} ) * μm , \qquad ( II )$$

wherein x is 50, more specifically 45, even more specifically 40 and in particular 35. The above formula (II) is used for convenience to further limit the formula (I).

In some embodiments, the mathematical product of the tap density after 1500 tamps multiplied with the D99-value is between 10 and 55, more specifically between 15 and 50, even more specifically between 20 and 45, and in particular between 25 and 40 (g/cm³)*μm.

In some embodiments, the particulate anode material has a D50-value of its particle size distribution which is between 8 and 25 μm, more specifically between 10 and 22, and in particular between about 12 and 20 μm.

In some embodiments, the difference between the D99-value and the D50-value is 40 μm or less, more specifically 35 μm or less, even more specifically 30 μm or less, and in particular 25 μm or less. This relationship describes a relatively narrow particle size distribution in absolute values.

In some embodiments, the ratio of D90-value of the particle size distribution to the D10-value of the particle size distribution is less than 4.2, more specifically less than 4.0, more specifically less than 3.7 and in particular less than 3.5. This relationship describes a relatively narrow particle size distribution in relative values.

In some embodiments, the particulate anode material is characterized by a sum of total functional groups of the material of less or equal to 10 μmol/g. The sum of total of functional groups is defined as algebraical sum of all acidic and alkali chemical functions attached on the material surface. The sum of total of functional groups is advantageously less or equal to 10 μmol/g, because above 10 μmol/g the side reactions increase, and the interface is reduced. If you have more side reactions than the reversible capacity of the battery is reduced because of the formation of a larger amount of solid electrolyte interface. In some embodiments, the sum of total functional groups of the anode material is between 5.5 μmol/g-0.05 μmol/g, more specifically between 1 μmol/g-0.05 μmol/g.

In some embodiments, the particulate anode material has a distribution of particle circularities and the S50-value of said distribution is 0.85-1.0 and/or wherein the S99-value of said distribution is 0.95 to 1. This parameter is used in the art to characterize the shape of the graphite particles.

In some embodiments, the xylol density of the material is between 2.2 and 2.26 g/cm³. Measuring the xylol density is well-established in the art and can be done e.g. according to DIN 51901 (2006-11).

According to a second aspect of the present disclosure, there is provided an electrode comprising a particulate anode material. The particulate anode material may be as defined for the first aspect of the present disclosure.

According to a third aspect of the present disclosure, there is provided a battery comprising at least one electrode according to second aspect.

According to a fourth aspect of the present disclosure, there is provided a method of manufacturing the anode material according to the first aspect of the present disclosure, comprising the steps of: a) providing a carbonaceous graphitizable material and or a graphitic material and a graphitizable organic binder; b) mixing of materials of step a) by using a ratio of coke/pitch by 0.05 to 0.8; c) heating up to 950° C. obtain a carbonizes material; d) heating up to 3100° C. the carbonized material of step c) to obtain a graphitized material; e) mixing of powder of step d) with an organic graphitizable carbonaceous additive; and f) heating the mixture of step e) to a temperature of between 800° C. and 1100° C. The particulate anode material may be as defined for the first aspect of the present disclosure.

In some embodiments, after step b) follows step b1) forming a solid body and after step d) follows step d1) milling.

According to a fifth aspect of the present disclosure, there is provided the use of a particulate anode material according to the first aspect of the present disclosure for lithium-ion batteries, in particular for automotives. The particulate anode material may be as defined for the first aspect of the present disclosure.

The above-discussed findings also allow the provision of a particulate anode material for a lithium ion battery comprising graphite particles, wherein the anode material can be compressed onto a metal sheet to form a dense and fast wetting anode material layer, which anode material layer has a density p (in g/cm³) and a wetting time t_{w} (in s) which is described by the following formula (III)

$${t}_{w} = {x}_{1} \times ( ρ - 1 , 0 ) + {x}_{2} \times {e}^{( {x}_{3} \times ( ρ - 1 , 7 ) )} \qquad ( III )$$

wherein
ρ is the density of the anode material compressed onto a metal sheet and
x₁ is between 50 and 158; x₂ is between 3 and 150 x₃ is between 13 and 45.

This means that the coefficients x₁, x₂ and x₃ must have the following units:
x₁ [s cm³/g]
x₂ [s]
x₃ [s cm³/g]

The above formula describes wettability (more specifically the speed of wetting) in relation to the density of the compressed anode material. Preferably, the density ρ (in g/cm³) of anode material compressed onto a metal sheet is between about 1.35 and 1.9, more specifically 1.4 to 1.85, more specifically 1.45 to 1.8, and in particular 1.5 to 1.75. The wetting time t_{w} (in s) ranges from about 50 to about 600 seconds for these densities and is determined using standardized conditions and electrolyte solutions as described further below.

The anode material is compressed by calendering onto a metal sheet to achieve the target density. The measurement of the wettability is described below. The wettability of the anode material is important for the overall quality of the battery. During the production process of the battery the electrode material is wet by an electrolyte. Furthermore, if the wetting time of the electrode material is very high the electrode material is very inhomogeneous and the machine time and, thus, production time is undesirably high.

In some embodiments, the anode material has a ratio of tap density of tap1500/tap 30 of 1.0-2.2, preferably of 1.0-1.8, more preferably of 1.2 to 1.6. Tap1500 refers to the density after 1500 tamps and tap30 refers to the density after 30 tamps. If the tap density ratio is below 1.0 the packaging of the electrode material is not optimal which reduces the properties of the electrode. Poor packaging leads to a low tap density and has a negative effect on the densification of the electrode layer.

Measures for selecting and/or preparing graphites having the desired particle size distribution are well-known in the art and not particularly limited. For instance, the particles can be milled under conditions which result in smaller or bigger graphite particles and broader or narrower particle size distributions. It is also possible to classify graphite powders in size fractions and to recombine the size fractions to obtain a desired particle size distribution.

Measures for achieving a target tap density are also well-known in the art and not particularly limited. The tap density (e.g. the tap density after 1500 tamps) will i.a. depend on size and shape factors of the employed graphite and is a parameter that well-catalogued for most commercial graphite materials. Accordingly, selecting a suitable material is not an obstacle for the skilled person.

Turning to the method according to a fourth aspect of the present disclosure:

The carbonaceous graphitizable material is not particularly limited and can be a coke of a regular or needle type, in particular in such a way that its real density measured by helium is at least 2.05 g/cm³ and 2.18 g/cm³ at most.

The organic graphitizable carbonaceous additive is not particularly limited and can be an organic material which is graphitizable and/or can be carbonized at temperature of between 800° C. and 1100° C. Suitable examples include any kind of petroleum or plant-derived polymer as, for example, pitch, tar, bitumen or asphalt, an epoxy resin, polystyrene, phenolic resin, a polyurethan and a polyvinyl alcohol.

Regarding step f), the organic graphitizable carbonaceous additive is advantageously added in amount of between 0.5 and 10 wt.-%, in relation to the powder of step g), more specifically in the range of 3 to 10 wt.-%.

In some embodiments, after step b) can follow step b1) forming a solid body and after step d) can follow step d1) milling.

### BRIEF DESCRIPTION OF THE FIGURES

The concepts of the present disclosure will be illustrated with reference to the figures described in the following. The figures are for illustration only and do not limit the scope of the claims.

FIG. 1 is a SEM (scanning electron microscope)-picture showing a standard graphite anode material. It shows a material according to Comparative Example 1.

FIG. 2 is a SEM (scanning electron microscope)-picture showing a graphite anode material according to the present disclosure. It shows a material according to Example 1.

FIG. 3 is a SEM (scanning electron microscope)-picture showing a graphite anode material according to the present disclosure. It shows a material according to Example 2.

FIG. 4 shows the wetting times achieved with the materials of Examples 1 and 2 and Comparative Example 1.

### DETAILED DESCRIPTION

The present disclosure is illustrated with reference to the embodiments described in the following. The embodiments are for illustration only and do not limit the scope of the claims.

### Measurements

The following measuring methods (where appropriate: exemplarily) apply to above description and (again where appropriate) to the examples below.

### Functional Groups

The functional groups were determined by the Böhm Titration method (based on DIN ISO 11352). All the solution used for the determination had a concentration of 0,001 mol/l.

### Determination the Basic Functional Groups:

Few grams, e.g. 5 grams, of the samples were dropped in 200 ml of a diluted solution of HCl for 24 hours. After that, 3×20 ml were taken off and titrated with diluted NaOH.

### Determination of Acidic Functional Groups:

Few grams, e.g. 5 grams, of the samples were dropped in solution of 200 ml of lye (diluted solution of NaOH, Na₂CO₃, NaHCO₃) for 24 hours. After that, 20 or 30 ml of a diluted HCl solution were added. In the end, the solutions were titrated with diluted NaOH.

### Tap Density

The Tap density was measured adapted with a Granupac device by Granutools™. The powder is placed in a metallic tube with a rigorous automated initialization process. Afterwards, a light hollow cylinder is placed on the top of the powder bed to keep the powder/air interface flat during the packing dynamics process.

The tube containing the powder sample rose to a fixed height of AZ and performs free falls. The free fall height is fixed to AZ=1 mm. The height h of the powder bed is measured automatically after each tap.

### D10, D50, D90 and D99-Values

The measurement of the particle size distribution of the anode material is not particularly limited and can be measured using a laser diffraction particle size distribution analyzer, i.e. a device that provides the particle size distribution by a volume standard. Accordingly, the D10-value is the particle size at the point where, starting from the small diameter side of the obtained particle size distribution, the cumulative volume of the particles reaches 10 vol.-%. The D50-, D90- and D99-values are defined likewise.

### Circularity, S50 and S99-Value

The circularity of a particle may be measured by dynamic image analysis on the measuring device QICPIC with the RODOS dry disperser from the company Sympatec, Germany. The measuring method should comply with ISO 13322-2:2021. For a plurality of particles having a plurality of respective circularities, the S50 and S99 values of the obtained distributions of circularities are as defined above.

### Measurement of Wetting Time

### 1. Sample Preparation

Samples for density measurements were obtained by punching out circular disks of coated sheet material.

### 2. Determination of the Density of the Graphite Anode Material Layers

Density of anode material on the circular disk was determined by measuring the thickness of the anode material layer on the circular disk, calculating the volume of the anode material layer from the thickness, weighing the disk, subtracting the mass of the circular metal sheet in order to obtain the mass of the graphite anode material layer and then dividing the mass of the graphite anode material layer by the volume of the graphite anode material layer.

### 3. Determination of Wetting Times

Wetting times were determined by placing a drop of (1M LiPF₆, ethylene carbonate (EC)/ethylmethyl carbonate (EMC) (3/7 vol. ratio), with additives of vinyl carbonate 0.5 wt. %) in the center of an anode material layer of a circular disc and then determining the time until the complete drop was incorporated into the anode material layer.

The drop had a volume of 1 μl and was provided from a syringe with hydrophobized blunt cannula using a dosing device at a flow rate of 1 μl per minute. The syringe arranged vertically. The circular disk was placed on a table. The table with the circular disk was lifted in a controlled way until the drop hanging on the cannula touched the surface of the anode material layer. The table was then quickly moved down a little bit. The time (in seconds [s]) from the instance at which the drop was sitting on the graphite anode material layer until the complete drop was incorporated into the anode material layer is herein considered as the wetting time. The complete drop was considered incorporated into the anode material layer when no more reflections were observed on the surface of the layer.

### Preparation of Calendered Layers of Graphite Anode Material on a Metal Sheet

The graphite powder was added to a water-based solution of carboxymethyl cellulose (CMC). To this dispersion styrene-butadiene rubber (SBR) polymers is added as binder. Components are added in the proportion: Graphite/CMC/SBR=98/1/1 wt % to result in the final dispersion (slurry). Electrodes were prepared by coating the slurry onto copper foil using a laboratory coating machine KTF-S 20412 (Werner Mathis AG). After coating the electrode were dried and then compressed by calendering using a laboratory Calender CA 9 (Sumet Systems GmbH) in order to reach the desired final density in the electrode material layer.

### Example 1

A coke is mixed with pitch to obtain a homogeneous green mass. The green mass was shaped in a solid form and then the obtained blocks were fired at 800-950° C. The baked blocks were then graphitized at a temperature of at least 2750° C. but not higher than 3100° C. After cooling to room temperature, the graphitized material was crushed and ground into a fine powder material to achieve a D50 of between 10 and 20 μm.

The fine pulverized material was mixed by means of a mechanical mixing device with 10 wt.-% of solid organic graphitizable carbonaceous additive. The mixture of fine graphitic powder and additive was heated at temperatures between 800° C. and 1100° C. for several hours.

### Example 2

A homogeneous green mass is obtained mixing a fine-powdered coke with pitch. The particulate green mass is fired at 800-950° C. and afterwards graphitized at a temperature of at least 2750° C. but not higher than 3100° C. and then cooled to room temperature. The graphitized material had a D50 which was somewhat smaller than in Example 1 and a particle size distribution which was narrower than in Example 1.

### Comparative Example 1

Similarly to Example 1, a coke is mixed with pitch to obtain a homogeneous green mass. The green mass was shaped in a solid form and then the obtained blocks were fired at 800-950° C. The baked blocks were then graphitized at a temperature of at least 2750° C. but not higher than 3100° C. After cooling to room temperature, the graphitized material was crushed and ground under different conditions to Example 1 into a fine powder material to achieve a D50 of between 10 and 20 μm, but with a broader particle size distribution than in Example 1.

The fine pulverized material was mixed by means of a mechanical mixing device with 10 wt.-% of solid organic graphitizable carbonaceous additive. The mixture of fine graphitic powder and additive was heated at temperatures between 800° C. and 1100° C. for several hours.

The prepared materials had the following properties:

| | | Material Type | | |
|---|---|---|---|---|
| Parameter | Unit | Ex. 1 | Ex. 2 | Comp. Ex. 1 |

Particle size distribution

| | | | | |
|---|---|---|---|---|
| D10 | [μm] | 8.41 | 7.06 | 8.11 |
| D50 | [μm] | 17.90 | 13.5 | 17.87 |
| D90 | [μm] | 31.35 | 23.5 | 35.60 |
| D99 | [μm] | 48.77 | 33.98 | 64.7 |

Tap density

| | | | | |
|---|---|---|---|---|
| 30 tamps | (g/cm³) | 0.73 | 0.82 | 0.84 |
| 250 tamps | (g/cm³) | 0.79 | 0.92 | 0.95 |
| 1500 tamps | (g/cm³) | 0.82 | 0.95 | 0.99 |
| Ash content | [%] | 0.013 | 0.004 | 0.050 |
| Fe | [ppm] | 3.7 | 2.07 | 17.6 |
| D99 * tap density | (g/cm³) | 39.99 | 32.28 | 64.05 |
| 1500 tamps | * μm | | | |
| Ratio D90/D10 | | 3.73 | 3.33 | 4.39 |
| Xylol density | (g/cm³) | 2.25 | 2.25 | 2.23 |
| Discharge | mAh/g | 356 | 347 | 356 |
| Capacity | | | | |
| First Discharge | [%] | 90.3 | 92.4 | 92.0 |
| Efficiency | | | | |

For the materials of Examples 1 and 2 and Comparative Example 1, the wetting times as shown in FIG. 4 were obtained.

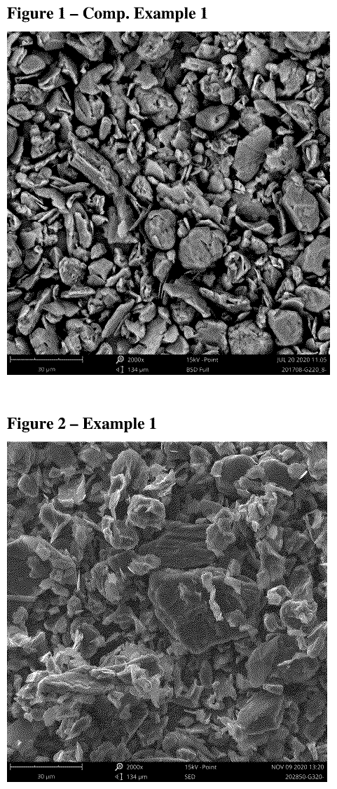

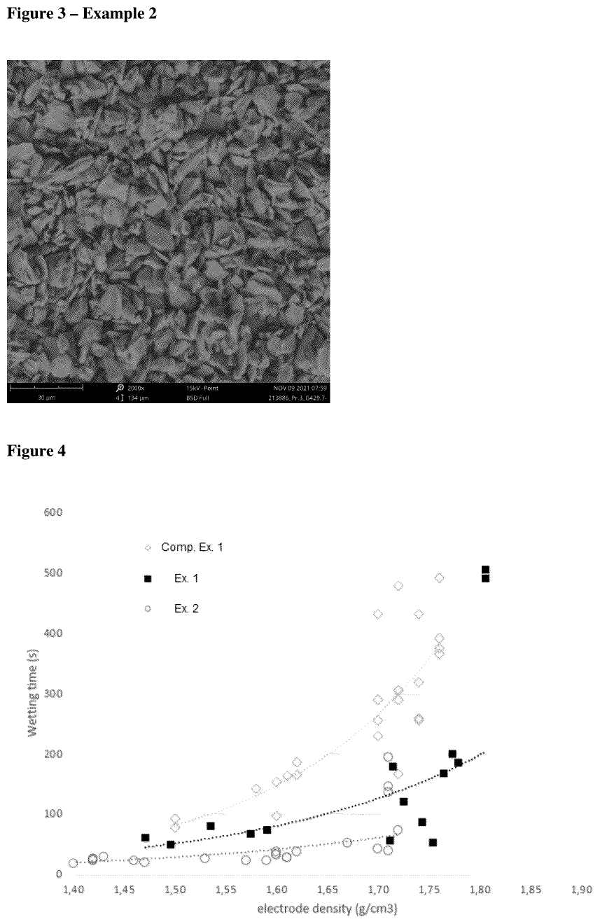

As can be seen from the above table, the graphites of Examples 1 and 2 and Comparative Example 1-despite having similar morphologies (see FIGS. 1 to 3) have different tapping densities. However, as evident from a comparison of the tapping density at 1500 tamps of Examples 1 and 2, the tapping density alone does not govern the obtainable wetting performance. As evident from FIG. 4, Example 2 outperforms Example 1 in this respect even though the tapping density is higher. However, once surface area via particle size (distribution) is additionally taken into consideration, the wetting time correlates to the product of D99*tap density at 1500 tamps which is consistent with the aforementioned interpretation as the product of D99*tap density at 1500 tamps being a descriptor of void space and capillarity within the compacted graphite powder. Moreover, a relatively narrow particle size distribution, as suggested by the ratio D90/D10 in particular of Examples 1 and 2, also seems to facilitate wettability.

The formula (III) was derived from a regressional analysis of the data shown in in FIG. 4. Regressional trends are indicated in FIG. 4 by the three full lines. Formula (III) is derived from a regressional analysis of data of Example 1.

1-15. (canceled)

16. A particulate anode material for a lithium ion battery comprising graphite particles, wherein the particulate anode material has D99-value for its particle size distribution of 20-75 μm and a tap density after 1500 tamps of 0.7-1.2 g/cm³, wherein the tap density after 1500 tamps and the particle size fulfill the relationship of formula (I):
$$tap density after 1500 tamps * D 99 < 55 ( g / {cm}^{3} ) * μm .$$

17. The particulate anode material according to claim 16, wherein the D99-value is 20-60 μm, more specifically 25-50 μm, and in particular 30-45 μm.

18. The particulate anode material according to claim 16, wherein the tap density after 1500 tamps of 0.75-1.15 g/cm³, more specifically 0.80-1.10 g/cm³, and in particular 0.85-1.00 g/cm³.

19. The particulate anode material according to claim 16, wherein the tap density after 1500 tamps and the particle size fulfill the relationship of formula (II):
$$tap density after 1500 tamps * D 99 < x ( g / {cm}^{3} ) * μm , \qquad ( II )$$
wherein x is 50, more specifically 45, even more specifically 40 and in particular 35.

20. The particulate anode material according to claim 16, wherein the mathematical product of the tap density after 1500 tamps multiplied with the D99-value is between 10 and 55, more specifically between 15 and 50, even more specifically between 20 and 45, and in particular between 25 and 40 (g/cm³)*μm.

21. The particulate anode material according to claim 16, wherein the D50-value of the particle size distribution is between 8 and 25 μm, more specifically between 10 and 22, and in particular between about 12 and 20 μm.

22. The particulate anode material according to claim 16, wherein the difference between the D99-value and the D50-value is 40 μm or less, more specifically 35 μm or less, even more specifically 30 μm or less, and in particular 25 μm or less.

23. The particulate anode material according to claim 16, wherein the ratio of D90-value of the particle size distribution to the D10-value of the particle size distribution is less than 4.2, more specifically less than 4.0, more specifically less than 3.7 and in particular less than 3.5.

24. The particulate anode material according to claim 16, wherein sum of total functional groups of the material is less or equal to 10 μmol/g.

25. The particulate anode material according to claim 16, wherein the particulate anode material has a distribution of particle circularities and the S50-value of said distribution is 0.85-1.0 and/or wherein the S99-value of said distribution is 0.95 to 1.

26. The particulate anode material according to claim 16, wherein the xylol density of the material is between 2.2 and 2.26 g/cm³.

27. An electrode comprising a particulate anode material according to claim 16.

28. A battery comprising at least one electrode according to claim 26.

29. A method of manufacturing the anode material according to claim 16, comprising the steps of:
a) providing a carbonaceous graphitizable material and or a graphitic material and a graphizable organic binder
b) mixing of materials of step a) by using a ratio of coke/pitch by 0.05 to 0.8.
c) heating up to 950° C. obtain a carbonizes material
d) heating up to 3100° C. the carbonized material of step c) to obtain a graphitized material
e) mixing of powder of step d) with an organic graphitizable carbonaceous additive
f) heating the mixture of step e) to a temperature of between 800° C. and 1100° C.

30. The method of manufacturing the anode material according to claim 28, wherein after step b) follows step b1) forming a solid body and after step d) follows step d1) milling.
